(19) United States
(12) Patent Application Publication
(10) Pub. No.: US 2026/0319423 A1
(43) Pub. Date: Oct. 15, 2026

(54) IMAGE FORMING APPARATUS THAT PERFORMS STATIC ELIMINATION OF SHEET WITH TONER IMAGE TRANSFERRED

(71) Applicant: KYOCERA Document Solutions Inc., Osaka (JP)

(72) Inventor: Takuro MORITA, Osaka (JP)

(73) Assignee: KYOCERA Document Solutions Inc., Osaka (JP)

(21) Appl. No.: 19/640,773

(22) Filed: Apr. 7, 2026

(30) Foreign Application Priority Data
Apr. 10, 2025 (JP) 2025-065287

(51) Int. Cl. G03G 15/00; G03G 15/01; G03G 15/16

(52) U.S. Cl. CPC G03G 15/657; G03G 15/1615; G03G 15/0131; G03G 15/0189; G03G 2215/00687

(57) ABSTRACT

An image forming apparatus includes an intermediate transfer belt, a driving roller, a secondary transfer roller, a first static eliminator, a driven rotator, a first guide, and a second static eliminator. The first static eliminator is provided downstream of a transfer nip portion in a sheet transport direction. The driven rotator is provided downstream of the first static eliminator in the sheet transport direction. The first guide is provided downstream of the driven rotator in the sheet transport direction. The second static eliminator extends along a surface opposite to a sheet transport side in the first guide.

### INCORPORATION BY REFERENCE

This application claims priority to Japanese Patent Application No. 2025-065287 filed on Apr. 10, 2025, the entire contents of which are incorporated by reference herein.

### BACKGROUND

The present disclosure relates to an image forming apparatus, and in particular, to a technique for performing static elimination of a sheet having a toner image secondarily transferred thereto.

An electrophotographic image forming apparatus that primarily transfers a toner image on a surface of a photosensitive drum to a surface of an intermediate transfer belt and secondarily transfers the toner image on the surface of the intermediate transfer belt to a sheet is known.

In such an image forming apparatus, the sheet may be charged in a process of secondary transfer. When an amount of charge of the sheet is large, for example, there is a problem in that the sheet becomes stuck or the like to a guide provided between a transfer nip portion in which secondary transfer is performed and a fixing device, the sheet is not stably transported, and the sheet is twisted, causing image defects, wrinkles of the sheet, or the like.

To solve such a problem, for example, a general first technique that disposes a static elimination plate downstream of a secondary transfer nip portion in a sheet transport direction such that a longitudinal direction is parallel to an axial direction of a secondary transfer roller, and a transverse direction of the static elimination plate is controlled to be oriented according to the charge polarity of a sheet is known.

Further, as a general second technique, a printer including a resin transport guide that guides a sheet separated from a transfer roller to a fixing roller pair, and a coil spring that protrudes on a rib of the resin transport guide and comes into contact with the sheet guided by the rib of the resin transport guide to perform static elimination of the sheet is known.

### SUMMARY

As one aspect of the present disclosure, a technique improved over the above-described technique is proposed.

An image forming apparatus according to one aspect of the present disclosure includes an endless intermediate transfer belt, a driving roller, a transfer roller, a first static eliminator, a driven rotator capable of being rotated in a driven manner, a first guide, and a second static eliminator. The intermediate transfer belt has a front surface to which a toner image is transferred. The driving roller comes into contact with a back surface of the intermediate transfer belt to rotationally drive the intermediate transfer belt. The transfer roller faces the driving roller via the intermediate transfer belt to form a transfer nip portion in which a sheet is nipped and transported. The first static eliminator is provided on a side of the transfer roller with respect to the driving roller downstream of the transfer nip portion in a sheet transport direction. The driven rotator is provided downstream of the first static eliminator in the sheet transport direction at a position in contact with a rear surface of the sheet having passed through the transfer nip portion. The first guide is provided downstream of the driven rotator in the sheet transport direction on the side of the transfer roller such that a guide surface to guide transport of the sheet is laid along the sheet transport direction. The second static eliminator is provided to extend along a surface opposite to a sheet transport side in the first guide. The first guide is provided with apertures that expose the second static eliminator to the sheet transport side.

### BRIEF DESCRIPTION OF THE DRAWINGS

FIG. 1 is a front cross-sectional view showing a structure of an image forming apparatus.

FIG. 2 is a block diagram showing a configuration of the image forming apparatus.

FIG. 3 is a partial enlarged view of the vicinity of an image forming device and a fixing device.

FIG. 4 is a partial perspective view of the vicinity of a secondary transfer roller when viewed from above in a state in which a configuration on a side of a driving roller is detached.

FIG. 5 is a diagram schematically showing a disposition position of a driven rotator.

FIG. 6 is a diagram showing a driven rotator according to a first modification example.

FIG. 7 is a diagram schematically showing a disposition position of the driven rotator according to the first modification example.

### DETAILED DESCRIPTION

Hereinafter, an image forming apparatus according to an embodiment of the present disclosure will be described with reference to the drawings.

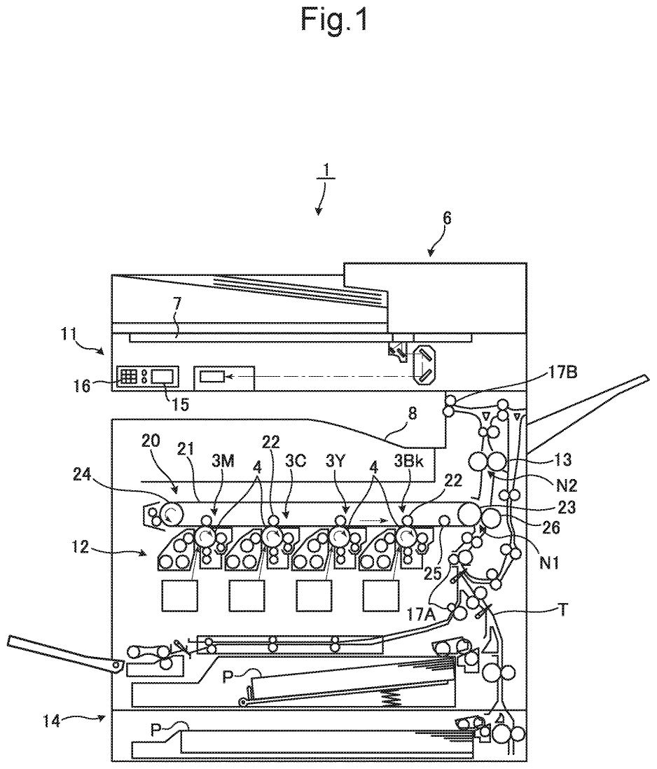

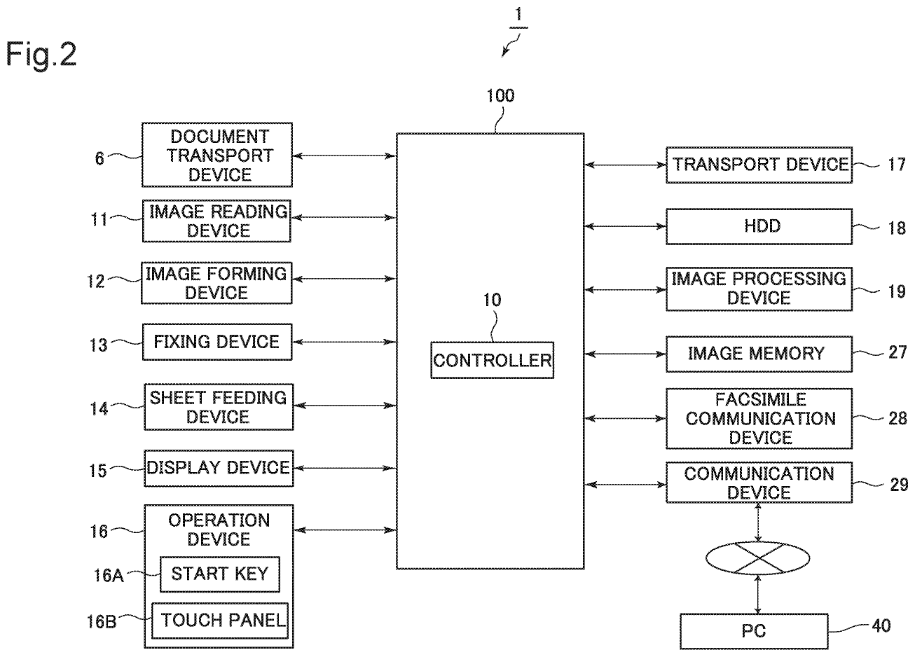

FIG. 1 is a front cross-sectional view showing a structure of an image forming apparatus 1 according to an embodiment of the present disclosure. FIG. 2 is a block diagram showing a configuration of the image forming apparatus 1. Referring to FIGS. 1 and 2, the image forming apparatus 1 is a multifunction peripheral including a plurality of functions such as a copy function, a transmission function, a printer function, and a facsimile function.

As shown in FIGS. 1 and 2, the image forming apparatus 1 includes a document transport device 6, an image reading device 11, an image forming device 12, a fixing device 13, a sheet feeding device 14, a display device 15, an operation device 16, and a transport device 17.

The document transport device 6 transports documents placed on a document tray to a reading position of the image reading device 11 one by one.

The image reading device 11 reads a document transported by the document transport device 6 or a document placed on a platen glass 7 to generate image data indicating a document image.

The image forming device 12 forms a toner image on a sheet P on the basis of an image indicated by the image data. The image forming device 12 includes an image forming unit 3M for magenta, an image forming unit 3C for cyan, an image forming unit 3Y for yellow, and an image forming unit 3Bk for black.

Each of the image forming units 3M, 3C, 3Y, and 3Bk includes a photosensitive drum 4 serving as an image carrier, a charging device, an exposure device, and a developing device. The charging device uniformly charges the surface of the photosensitive drum 4. The exposure device exposes the surface of the photosensitive drum 4 to form an electrostatic latent image on the surface of the photosensitive drum 4. The developing device develops the electrostatic latent image on the surface of the photosensitive drum 4 into a toner image.

The image forming device 12 further includes an intermediate transfer unit 20. The intermediate transfer unit 20 includes an intermediate transfer belt 21, four primary transfer rollers 22, a driving roller 23, a tension roller 24, and a support roller 25.

The intermediate transfer belt 21 is an endless belt having a surface onto which a toner image is to be transferred. The intermediate transfer belt 21 is stretched around the four primary transfer rollers 22, the driving roller 23, the tension roller 24, and the support roller 25.

The driving roller 23 comes into contact with a back surface of the intermediate transfer belt 21 to rotationally drive the intermediate transfer belt 21. That is, the intermediate transfer belt 21 is driven by the driving roller 23 and circularly moves. The driving roller 23 is a cylindrical roller that extends in a width direction of a sheet to be transported, that is, a belt width direction perpendicular to a traveling direction of the intermediate transfer belt 21, and is provided to have a length equal to or greater than a width of the intermediate transfer belt 21.

Each of the four primary transfer rollers 22 is pressed against the photosensitive drum 4 in each of the image forming units 3M, 3C, 3Y, and 3Bk via the intermediate transfer belt 21. When the driving roller 23 is rotationally driven, the intermediate transfer belt 21 comes into contact with each photosensitive drum 4 while circularly moving, and the toner images in the respective colors are primarily transferred from the respective photosensitive drums 4 to the intermediate transfer belt 21 and superimposed.

The image forming device 12 further includes a secondary transfer roller 26. The secondary transfer roller 26 faces the driving roller 23 via the intermediate transfer belt 21 to form a transfer nip portion N1 in which the sheet P is nipped and transported. A color toner image formed on the surface of the intermediate transfer belt 21 is secondarily transferred to the sheet P that is transported from the sheet feeding device 14 through a transport path T, in the transfer nip portion N1. The secondary transfer roller 26 is a cylindrical roller that extends in the same direction as the driving roller 23, and is provided to have a length almost equal to that of the driving roller 23.

The fixing device 13 includes a fixing roller having a heater inside, and a pressing roller that is pressed against the fixing roller. The fixing device 13 fixes the toner image to the sheet P by heating and pressing the sheet P to which the toner image is secondarily transferred, in a fixing nip portion N2 formed between the fixing roller and the pressing roller. The sheet P to which the toner image is fixed and on which an image is formed is discharged to a discharge tray 8.

The sheet feeding device 14 includes a manual feeding tray, and a plurality of sheet feeding cassettes. The sheet feeding device 14 draws out sheets P stored in one of the plurality of sheet feeding cassettes or sheets placed in the manual feeding tray one by one using a pick-up roller and feeds the sheet P to the transport path T. The sheet P is not limited to a paper medium, and may be an overhead projector (OHP) sheet.

The display device 15 is a liquid crystal display, an organic EL (organic light-emitting diode) display, or the like. The display device 15 displays various screens.

The operation device 16 includes a plurality of hard keys such as a start key 16A for inputting an execution start command of copy processing, scan processing, or the like. The operation device 16 further includes a touch panel 16B that is provided to overlap the display device 15. To the operation device 16, a user's instruction is input.

The transport device 17 includes a transport roller pair 17A, a discharge roller pair 17B, and the like, and a transport motor. When the transport roller pair 17A, the discharge roller pair 17B, and the like rotate with driving of the transport motor, the sheet P fed by the sheet feeding device 14 is transported along the transport path T.

Referring to FIG. 2, the image forming apparatus 1 further includes a control device 100, a hard disk drive (HDD) 18, an image processing device 19, an image memory 27, a facsimile communication device 28, and a communication device 29.

The control device 100 includes a processor, a random access memory (RAM), a read only memory (ROM), and the like. The processor is, for example, a central processing unit (CPU), a micro processing unit (MPU), or an application specific integrated circuit (ASIC).

The control device 100 functions as a controller 10 by a control program stored in the ROM or the HDD 18 being executed by the above-described processor. The controller 10 controls the operation of each device of the image forming apparatus 1. The controller 10 may be configured with a logic circuit regardless of an operation based on the control program.

The control device 100 is electrically connected to the document transport device 6, the image reading device 11, the image forming device 12, the fixing device 13, the sheet feeding device 14, the display device 15, the operation device 16, the transport device 17, the HDD 18, the image processing device 19, the image memory 27, the facsimile communication device 28, the communication device 29, and the like.

The HDD 18 is a large capacity storage device for storing various kinds of data. The HDD 18 stores various control programs for realizing general operations of the image forming apparatus 1.

The image processing device 19 executes image processing on image data generated by the image reading device 11 as necessary. The image memory 27 temporarily stores the image data generated by the image reading device 11. The facsimile communication device 28 performs transmission and reception of image data via a public line.

The communication device 29 includes a communication module such as a local area network (LAN) board. The controller 10 performs data communication with an external apparatus such as a personal computer (PC) 40 connected via a network, via the communication device 29.

A power supply is connected to each device of the image forming apparatus 1. When a user applies power, power is supplied from the power supply to each device of the image forming apparatus 1.

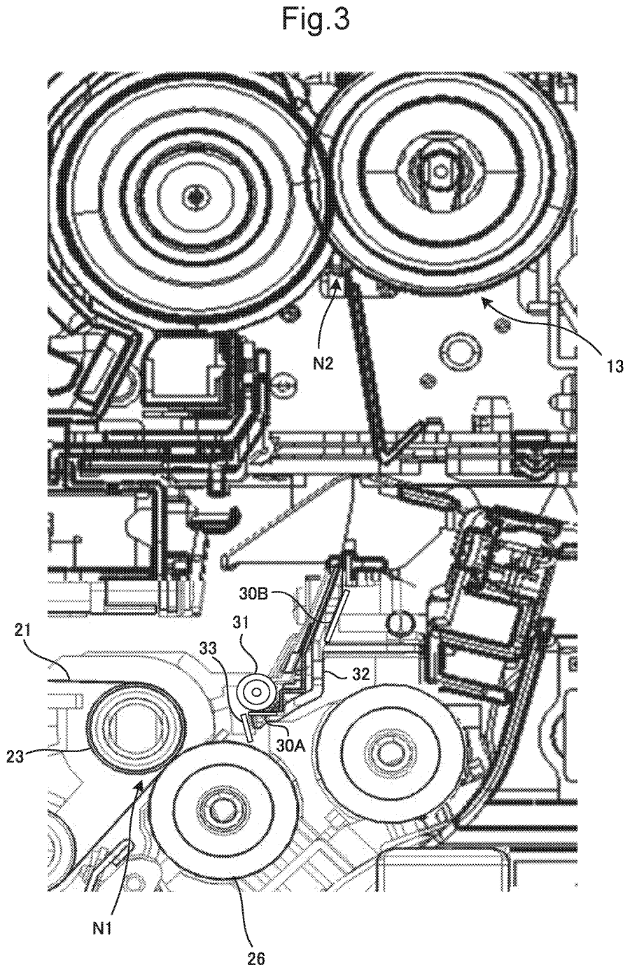

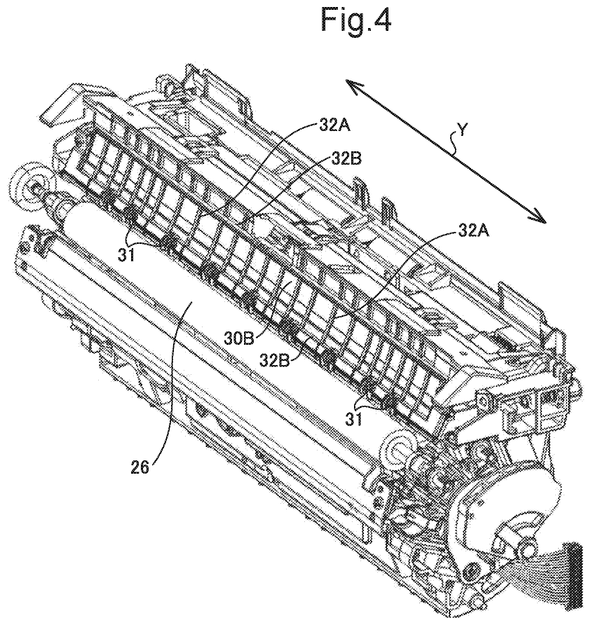

FIG. 3 is a partial enlarged view of the vicinity of the image forming device 12 and the fixing device 13. FIG. 4 is a partial perspective view of the vicinity of the secondary transfer roller 26 when viewed from above in a state in which a configuration on a side of the driving roller 23 is detached. As shown in FIGS. 3 and 4, the image forming apparatus 1 further includes a first static eliminator 30A, a second static eliminator 30B, a driven rotator 31, a first guide 32, and a second guide 33.

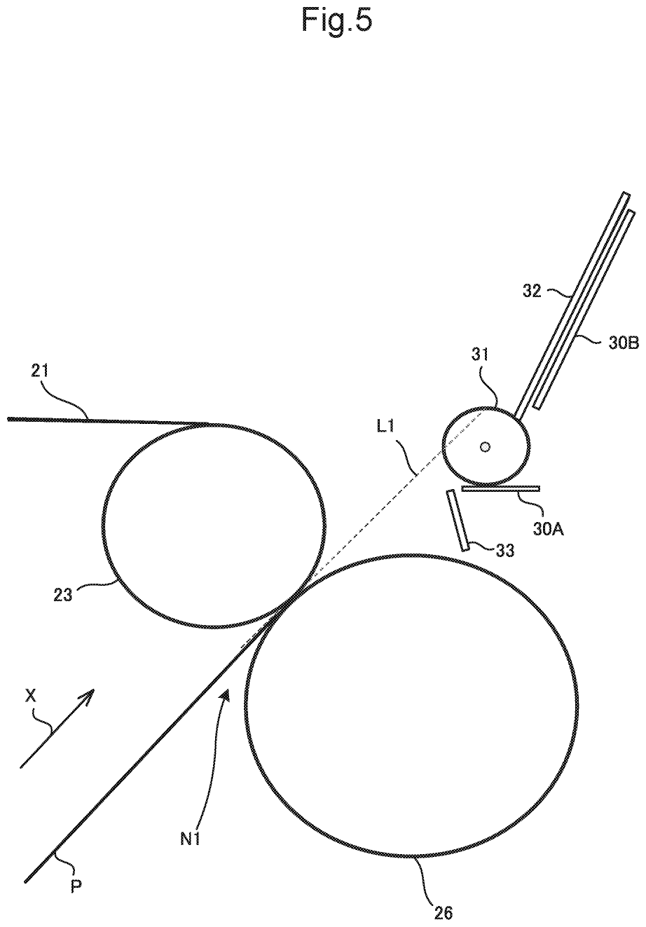

The first static eliminator 30A is provided downstream of the transfer nip portion N1 in the sheet transport direction X (see FIG. 5) on the side of the secondary transfer roller 26 with respect to the driving roller 23. The first static eliminator 30A is, for example, a stainless conductive plate-like component that extends with an axial direction of the secondary transfer roller 26 and the driving roller 23 as a longitudinal direction. One end of the first static eliminator 30A in a transverse direction is processed in a saw tooth shape. A pitch between adjacent saw teeth is, for example, 1 mm.

The first static eliminator 30A is disposed such that the longitudinal direction is parallel to the axis of the secondary transfer roller 26, and a tip portion of the saw tooth is directed toward the transfer nip portion N1. The first static eliminator 30A is also grounded.

The sheet P charged with secondary transfer of the toner image moves in the vicinity of the first static eliminator 30A when having passed through the transfer nip portion N1. In this case, an ion flux is generated between the tip portion of the saw tooth of the first static eliminator 30A and the charged sheet P, and charge moves from the charged sheet P toward the first static eliminator 30A. In this manner, the sheet P is subjected to static elimination.

The driven rotator 31 is a driven roller capable of being rotated in a driven manner that is provided downstream of the first static eliminator 30A in the sheet transport direction X at a position in contact with a rear surface of the sheet P having passed through the transfer nip portion N1. The driven rotator 31 is supported by the first guide 32 to be rotatable in a driven manner.

In the present embodiment, the driven rotator 31 is formed such that a shape when viewed from the axial direction is a circular shape. The driven rotator 31 comes into contact with the rear surface of the sheet P that passes through the transfer nip portion N1 and is transported toward the fixing nip portion N2 and is rotated in a driven manner.

As shown in FIG. 4, the driven rotator 31 is configured with a plurality of cylindrical rollers that have a rotation axis extending in the axial direction of the secondary transfer roller 26 and the driving roller 23 and are juxtaposed with a gap over a length to the same extent as the width of the intermediate transfer belt 21. The driven rotator 31 may be configured with one roller that has a rotation axis extending in the axial direction of the secondary transfer roller 26 and the driving roller 23 and has a length to the same extent as the width of the intermediate transfer belt 21.

The first guide 32 includes a plurality of ribs 32A that extends along the sheet transport direction X. The plurality of ribs 32A are disposed to be arranged while leaving a space determined in advance along a width direction Y perpendicular to the sheet transport direction X. Both end portions of the plurality of ribs 32A are connected to rods 32B extending along the width direction Y, respectively. Apertures that expose the second static eliminator 30B to a sheet transport side are formed in the first guide 32 by the plurality of ribs 32A and two rods 32B.

The plurality of ribs 32A are made of a non-conductive resin material. The plurality of ribs 32A form a guide surface to guide transport of the sheet P having passed through the transfer nip portion N1 toward the fixing nip portion N2. The first guide 32 is provided downstream of the driven rotator 31 in the sheet transport direction X on the side of the secondary transfer roller 26 with respect to the driving roller 23 in a state in which the guide surface of the plurality of ribs 32A is laid along the sheet transport direction X.

The second static eliminator 30B is provided to extend along a surface (that is, a surface opposite to the guide surface) opposite to the sheet transport side of the plurality of ribs 32A in the first guide 32. In the present embodiment, the second static eliminator 30B is made of conductive non-woven fabric. The second static eliminator 30B may be made of a sheet metal.

In the present embodiment, the second static eliminator 30B is provided to come into contact with the surface opposite to the sheet transport side in the plurality of ribs 32A of the first guide 32. The second static eliminator 30B may be provided to be placed at a given distance from the surface opposite to the sheet transport side in the plurality of ribs 32A of the first guide 32.

A size of the second static eliminator 30B is not particularly limited, and is, for example, such a size that a length in the longitudinal direction is almost equal to a length of the secondary transfer roller 26 in the axial direction, and a length in the transverse direction is almost equal to a length of the plurality of ribs 32A in the sheet transport direction X.

The sheet P subjected to static elimination by the first static eliminator 30A moves toward the fixing nip portion N2 along the guide surface in the plurality of ribs 32A of the first guide 32. In this case, the sheet P moves in the vicinity of the second static eliminator 30B through the first guide 32. In this case, slight residual charge in the sheet P moves from the sheet P toward the second static eliminator 30B. In this manner, the residual charge of the sheet P is eliminated.

The second guide 33 is an insulating component (for example, a plate-like component or a sheet component) that is provided upstream of the driven rotator 31 in the sheet transport direction X between the first static eliminator 30A and the secondary transfer roller 26 to shield therebetween. The second guide 33 is made of, for example, polyethylene terephthalate (PET).

FIG. 5 is a diagram schematically showing a disposition position of the driven rotator 31. Referring to FIG. 5, the driven rotator 31 is provided such that, with respect to a virtual flow line L1 along which a leading edge of the sheet P having passed through the transfer nip portion N1 is supposed to move when it is assumed that there is no driven rotator 31, a rotation center of the driven rotator 31 is positioned on a side of the secondary transfer roller 26, and a rotation surface of the driven rotator 31 protrudes to the side of the driving roller 23.

Incidentally, in the above-described general first and second techniques, while static elimination of the charged sheet is performed by the static elimination plate or the coil spring, when an amount of static elimination is insufficient, twist of the sheet may not be sufficiently prevented. However, when an amount of single static elimination is increased, unfixed toner on the sheet may be scattered.

In contrast, according to the above-described embodiment, the driven rotator 31 is provided downstream of the first static eliminator 30A in the sheet transport direction X. The first guide 32 is provided downstream of the driven rotator 31 in the sheet transport direction X. The second static eliminator 30B is provided to extend along a surface opposite to a sheet transport side of the plurality of ribs 32A in the first guide 32.

That is, in the above-described embodiment, the first static eliminator 30A is provided upstream of the driven rotator 31 in the sheet transport direction X, and the second static eliminator 30B is provided downstream of the driven rotator 31 in the sheet transport direction X. In this way, because the static eliminators are disposed dividedly, it is possible to perform static elimination of the charged sheet P in a distributed manner. As a result, it is possible to sufficiently perform static elimination of the sheet with a stable amount of static elimination without increasing an amount of single static elimination. Therefore, it is possible to stably perform static elimination of the sheet with a simple configuration.

According to the above-described embodiment, the first guide 32 is provided with the apertures that expose the second static eliminator 30B to the sheet transport side. With this, it is possible to more efficiently eliminate residual charge of the sheet P.

According to the above-described embodiment, the second static eliminator 30B is made of the conductive non-woven fabric or the sheet metal. With this, the second static eliminator 30B attracts slight residual charge on the sheet P subjected to static elimination by the first static eliminator 30A, and accordingly, the sheet P is attracted to the guide surface of the first guide 32 and transported. As a result, it is possible to stably transport the sheet P in a state of being difficult to be twisted.

According to the above-described embodiment, the driven rotator 31 is supported by the first guide 32. With this, because there is no need for separately providing a part for supporting the driven rotator 31, it is possible to suppress an increase in cost due to an increase in the number of parts.

According to the above-described embodiment, the second static eliminator 30B is provided to come into contact with the surface opposite to the sheet transport side in the plurality of ribs 32A of the first guide 32. With this, it is possible to reliably move slight residual charge in the sheet P toward the second static eliminator 30B. Therefore, it is possible to further eliminate the residual charge of the sheet P.

According to the above-described embodiment, the driven rotator 31 is provided such that, with respect to the virtual flow line L1 along which the leading edge of the sheet P having passed through the transfer nip portion N1 is supposed to move when it is assumed that there is no driven rotator 31, the rotation center of the driven rotator 31 is positioned on the side of the secondary transfer roller 26, and the rotation surface of the driven rotator 31 protrudes to the side of the driving roller 23.

With this, the driven rotator 31 comes into contact with and supports the sheet P moving in the sheet transport direction X to regulate a moving direction of the sheet P, and a distance between the first static eliminator 30A and the moving sheet P can be kept constant to be an appropriate distance. As a result, it is possible to stably perform initial static elimination of the sheet P. Further, it is possible to keep a deflection amount constant when the sheet P reaches the fixing nip portion N2. As a result, it is possible to more stably transport the sheet P.

According to the above-described embodiment, the image forming apparatus 1 further includes the insulating second guide 33 that is provided between the first static eliminator 30A and the secondary transfer roller 26 to shield therebetween.

In this case, because the second guide 33 is provided between the first static eliminator 30A and the secondary transfer roller 26 to shield therebetween, it is possible to prevent the sheet P moving in the sheet transport direction X from moving toward the first static eliminator 30A. In addition, it is possible to prevent leakage of a high voltage between the first static eliminator 30A and the secondary transfer roller 26.

### First Modification Example

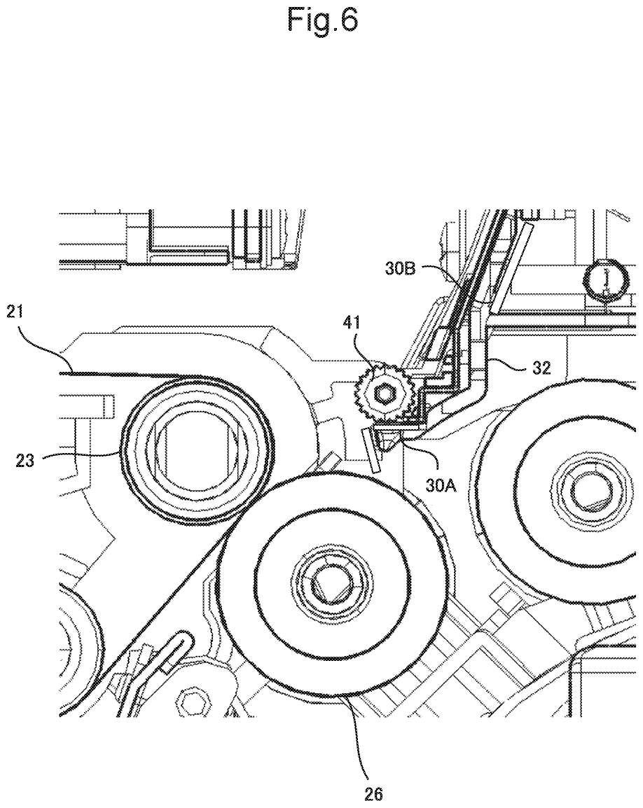

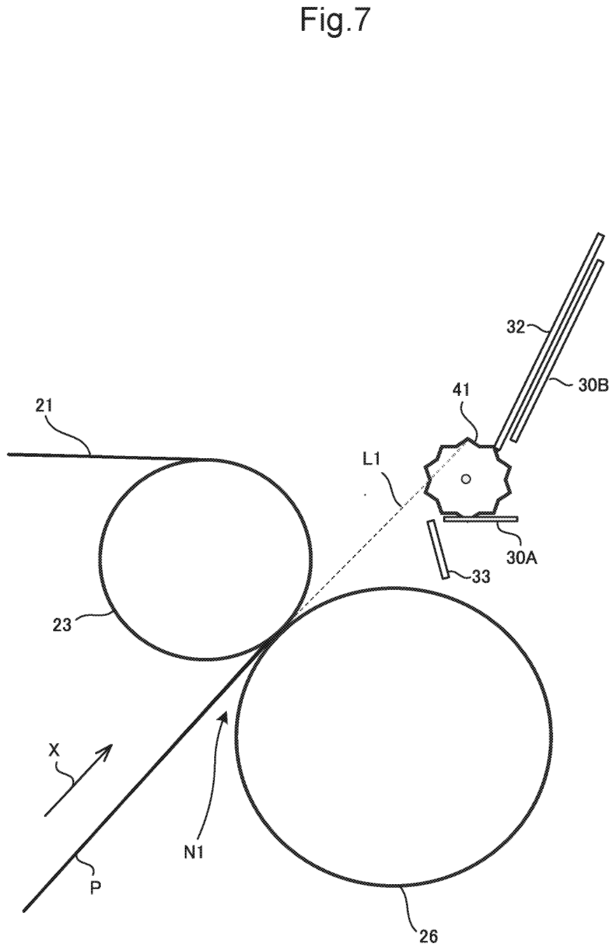

In the above-described embodiment, while the driven rotator 31 is formed such that a shape when viewed from the axial direction is a circular shape, the present disclosure is not limited to such an embodiment. FIG. 6 is a diagram showing a driven rotator 41 according to a first modification example of the embodiment. FIG. 7 is a diagram schematically showing a disposition position of the driven rotator 41.

As shown in FIG. 6, the driven rotator 41 according to the first modification example is formed such that a shape when viewed from the axial direction is a corrugated shape (for example, a star shape or a throwing star shape) with a plurality of protrusions compactly arranged on a cylindrical outer circumferential surface. Specifically, in the driven rotator 41, a plurality of teeth that extend in the axial direction are formed radially at given intervals as the above-described protrusions along the outer circumferential surface of the driven rotator 41.

Referring to FIG. 7, similarly to the driven rotator 31 according to the above-described embodiment, the driven rotator 41 is provided such that a rotation center of the driven rotator 41 is positioned on the side of the secondary transfer roller 26 with respect to the virtual flow line along which the leading edge of the sheet P having passed through the transfer nip portion N1 is supposed to move when it is assumed that there is no driven rotator 41, and a rotational surface of the driven rotator 41 protrudes to the side of the driving roller 23.

According to the first modification example, because the driven rotator 41 has the corrugated shape with the plurality of protrusions arranged compactly on the outer circumferential surface, the leading edge of the sheet P that moves in the sheet transport direction abuts on the side surface of the corrugated protrusion, so that the driven rotator 41 can be easily rotated.

### Other Modification Examples

In the above-described embodiment, while a multifunction peripheral is used as the image forming apparatus 1, this is merely an example, and other image forming apparatuses such as a printer, a copy machine, and a facsimile apparatus may be used.

The configuration described using FIGS. 1 to 7 is merely one embodiment of the present disclosure, and is not intended to limit the present disclosure to the configuration.

While the present disclosure has been described in detail with reference to the embodiments thereof, it would be apparent to those skilled in the art that the various changes and modifications may be made therein within the scope defined by the appended claims.

What is claimed is:

1. An image forming apparatus comprising:
an endless intermediate transfer belt having a surface to which a toner image is transferred;
a driving roller that comes into contact with a back surface of the intermediate transfer belt to rotationally drive the intermediate transfer belt;
a transfer roller that faces the driving roller via the intermediate transfer belt to form a transfer nip portion in which a sheet is nipped and transported;
a first static eliminator that is provided downstream of the transfer nip portion in a sheet transport direction on a side of the transfer roller with respect to the driving roller;
a driven rotator capable of being rotated in a driven manner that is provided downstream of the first static eliminator in the sheet transport direction at a position in contact with a rear surface of the sheet having passed through the transfer nip portion;
a first guide that is provided downstream of the driven rotator in the sheet transport direction on the side of the transfer roller such that a guide surface to guide transport of a sheet is laid along the sheet transport direction; and
a second static eliminator that is provided to extend along a surface opposite to a sheet transport side in the first guide,
wherein the first guide is provided with apertures that expose the second static eliminator to the sheet transport side.

2. The image forming apparatus according to claim 1,
wherein the second static eliminator is made of conductive non-woven fabric or a sheet metal.

3. The image forming apparatus according to claim 1,
wherein the driven rotator is supported by the first guide.

4. The image forming apparatus according to claim 1,
wherein the second static eliminator is provided to be in contact with the surface opposite to the sheet transport side in the first guide.

5. The image forming apparatus according to claim 1, further comprising:
an insulating second guide that is provided between the first static eliminator and the transfer roller to shield therebetween.

6. The image forming apparatus according to claim 1,
wherein the driven rotator is provided such that, with respect to a virtual flow line along which a leading edge of the sheet having passed through the transfer nip portion is supposed to move when it is assumed that there is no driven rotator, a rotation center of the driven rotator is positioned on the side of the transfer roller, and a rotation surface of the driven rotator protrudes to a side of the driving roller.

7. The image forming apparatus according to claim 1,
wherein the first guide includes a plurality of ribs that extend along the sheet transport direction and two rods that connect both end portions of the plurality of ribs, respectively, and
the plurality of ribs and the two rods form the apertures in the first guide.
